(19) United States
(12) Patent Application Publication
(10) Pub. No.: US 2012/0091292 A1
(43) Pub. Date: Apr. 19, 2012

(54) SHIFT CABLE HOLDER AND METHOD FOR MOUNTING SHIFT AND SELECTOR CABLES ON THE HOLDER

(75) Inventors: Thorsten HAHN, Gau-Odernheim (DE); Friedhelm KRAKE, Soest (DE); Miriam WOLF, Ruesselsheim (DE)

(73) Assignee: GM GLOBAL TECHNOLOGY OPERATIONS LLC, Detroit, MI (US)

(21) Appl. No.: 13/276,631

(22) Filed: Oct. 19, 2011

(30) Foreign Application Priority Data
Oct. 19, 2010 (DE) 102010048722.8

(51) Int. Cl. F16L 3/08; B23P 17/02; B23P 11/00

(52) U.S. Cl. 248/73; 248/65; 29/428

(57) ABSTRACT

A shift cable holder is provided for a transmission. In addition, a method is provided for mounting shift and selector cables on the holder. The shift cable holder has a base region. At a distance from the base region at least one retaining profile is provided for receiving at least one coupling element of a shift cable end. The shift cable holder has a guide lug, which projects beyond the retaining profile and is fixed to the retaining profile and has a guide edge.

### CROSS-REFERENCE TO RELATED APPLICATION

This application claims priority to German Patent Application No. 102010048722.8, filed Oct. 19, 2010, which is incorporated herein by reference in its entirety.

### TECHNICAL FIELD

The technical field generally relates to a shift cable holder and method for mounting shift and selector cables on the holder. The shift cable holder is used in automobiles with manual transmission.

### BACKGROUND

A gear change cable traction system is known from the document DE 100 16 888 A1. The gear change cable traction system is used to control the engagement of different gears of an automobile transmission. For this purpose the gear change cable traction has at least one core guided as a push-pull cable and at least one cladding at least partially surrounding the core. One end of the core is provided in the area of the transmission and is connected to a shift lever of the transmission in an articulated manner

To this end, the core is movable relative to the cladding, where at least a partial area of the cladding a counter bearing in the form of a coupling element is disposed in a retaining profile of the shift-fork holder can be secured in the area of the transmission. In this case, shift cable holder, retaining profile, and coupling element not only form a unit in the form of a counter bearing element but are at the same time an integral component of the gear change cable traction system and form an inseparable one-piece counter bearing unit.

At least one object is to provide a shift cable holder, having a retaining profile for a coupling element, which is disposed at the end of the shift cable. After mounting the shift cable holder on the transmission casing, the shift cable holder should enable the end of the shift cable to be fixed to the coupling element in an inexpensive and time-saving manner in the retaining profile of the shift cable holder. It is at least a further object to provide a method for mounting a shift and a selector cable on a transmission casing that enables shift and selector cable to be fixed in an inexpensive and time-saving manner to the retaining profiles of the cable holder. In addition, other objects, desirable features and characteristics will become apparent from the subsequent summary and detailed description, and the appended claims, taken in conjunction with the accompanying drawings and this background.

### SUMMARY

A shift cable holder is provided for a transmission comprising a base region. At a distance from the base region there is provided at least one retaining profile for receiving at least one coupling element of a shift cable end. The shift cable holder typically has a rod-shaped guide lug, which projects beyond the retaining profile and is fixed to the retaining profile and has a guide edge.

The shift cable holder has the advantage that the guide edge of the rod-shaped guide lug can be used to insert a coupling element of a shift cable end rapidly and securely into the retaining profile of the shift cable holder, despite the relative bending resistance of a shift cable end of such a push-pull cable that serves to transmit shifting movements to a shift lever on a transmission.

In one embodiment, the guide edge of the guide lug is disposed in such a manner that it goes over tangentially into the retaining profile. This is associated with the advantage that the coupling element of the shift cable end is merely to be brought into engagement with the guide edge of the guide lug and can be inserted along the tangential guide edge into the retaining profile of the shift cable holder. To this end, it is provided that the retaining profile is annular and has an opening toward the tangential guide edge of the guide lug, whose width corresponds to a diameter of the coupling element. Thus, the shift cable to be inserted with its coupling element on the shift cable end can be introduced directly along the tangential guide edge into the opening by gently turning the coupling element into the opening of the retaining profile.

In a further embodiment it is provided that the coupling element of the selector cable end is fixed on a cable cladding and has an annular channeling, which can be engaged into the retaining profile. In this case it is advantageous that the coupling element is fixed on the cladding of the shift cable end and can be securely mounted with its channeling in the retaining profile.

In this case, the guide edge of the guide lug has a thickness that is adapted to the annular channeling of the shift cable end and can be brought into engagement with this. This is additionally facilitated since the guide edge of the guide lug is not only beveled but can also have a frustroconical tapering toward the guide edge. The threading on or engagement of the coupling element with its channeling on the guide lug is thereby simplified.

It is furthermore provided that the base region has at least one through hole and at least one fixing element is provided in the base region, which is disposed in the through hole and fixes the shift cable holder on a seat of a transmission casing. This fixing ensures that the shift cable holder can now form a counter bearing for the end of the shift cable with the retaining profile and a shift cable that projects from the shift cable end can now transmit the relative movement between shift cable cladding and shift cable to a shift lever of the transmission.

The shift cable holder is a part of a shift cable retaining apparatus, where the shift cable holder comprises two retaining profiles in which a shift cable end of a shift cable and a selector cable end of one selector cable are fixed by means of the guide lugs assigned to the retaining profiles. The shift cable wire or selector cable wire projecting from the ends is fixed in an articulated manner on corresponding shift or selector levers of a transmission. Such a shift cable apparatus which now has two retaining profiles decisively simplifies the mounting of a shift cable end and a selector cable end which act on separate levers of a shift transmission.

A method is provided for mounting a shift and a selector cable on a transmission casing comprises the following process steps. A selector cable end and a shift cable end are provided with projecting selector or shift cables, where the cable ends have coupling elements placed on the respective cable cladding. A shift cable holder having retaining profiles for the selector cable end and the shift cable end can then be fixed on a transmission casing, where the shift cable end and the selector cable end each comprise an annular channeling of a coupling element.

These channelings of the respective coupling element are now latched into a guide edge of a guide lug and the cable end turned into the alignment of the retaining profile while supporting the cable end on the guide edge. A sliding displaceable lowering of the coupling element along the guide lug into the retaining profile can then be accomplished. An articulated fixing of the cable ends on corresponding transmission levers can then be carried out.

As a result of the possibility of latching channelings of the coupling elements of the cable ends into the guide edges of the guide lugs, the method for mounting a shift or a selector cable on a transmission casing will be simplified, speeded up, and accomplished more reliably than hitherto. To this end the coupling element can be shrunk onto the cable cladding or seamlessly connected to the cable cladding in order to ensure that the coupling element is not displaced on the cable cladding and with the shift cable holder together forms a reliable counter bearing both for the selector cable and also for the shift cable. An annular groove can be inserted in the coupling element as an annular channeling of the coupling elements. In addition, the guide lug in the area of the guide lug is tapered in the area of the guide edge in a frustroconical manner in order to facilitate the latching of the channeling of the respective coupling element into the guide edge of the guide tab.

### BRIEF DESCRIPTION OF THE DRAWINGS

The present invention will hereinafter be described in conjunction with the following drawing figures, wherein like numerals denote like elements, and:

FIG. 1 shows a schematic perspective view of a shift cable retaining apparatus on a transmission casing;

FIG. 2 shows a schematic perspective view of a shift cable holder in detail; and

FIG. 3 shows a schematic perspective view of the shift cable holder according to FIG. 1 when mounting a transmission side shift cable end.

### DETAILED DESCRIPTION

The following detailed description is merely exemplary in nature and is not intended to limit application and uses. Furthermore, there is no intention to be bound by any theory presented in the preceding background or summary or the following detailed description.

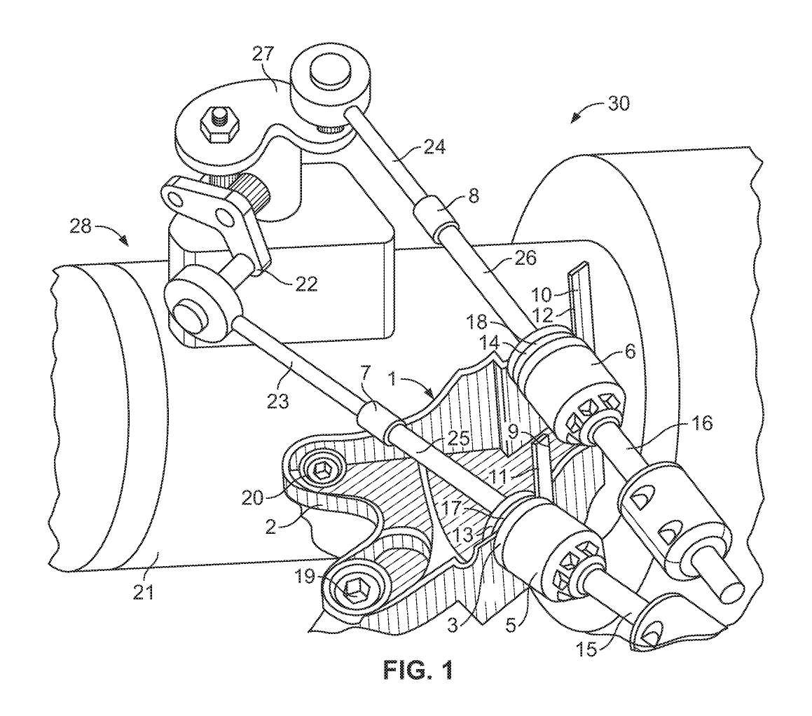

FIG. 1 shows a schematic perspective view of a shift cable retaining apparatus 30 on a transmission casing 21. The shift cable retaining apparatus 30 comprises a shift cable holder 1 which is fixed on a transmission casing 21. To this end the shift cable holder 1 has a base region 2 having two through holes 19, 20 in which screw elements are disposed for fixing the shift cable holder 1 on the transmission casing 21. The shift cable retaining apparatus 30 comprises two retaining profiles 3, 4 of the shift cable holder 1. Rod-shaped guide lugs 9, 10, each having a guide edge 11 or 12, are disposed on the retaining profiles 3, 4.

These guide edges 11 or 12 go over tangentially into the retaining profiles 3, 4 in which coupling elements 5 or 6 on the one hand for the selector cable end 7 and on the other hand for the shift cable end 8 are disposed with annular channelings 17 and 18. The coupling elements 5, 6 are fixed on the cable claddings 15, 16 of the selector cable 25 or of the shift cable 26 and each form a counter bearing firmly connected to the transmission casing 21 for the selector cable wire 23 or shift cable wire 24 projecting from the cable end, so that the movements of the selector cable wire 23 can be transmitted to a selector lever 22 of the transmission 28 and the movement of the shift cable wire 24 can be transmitted to the shift lever 27.

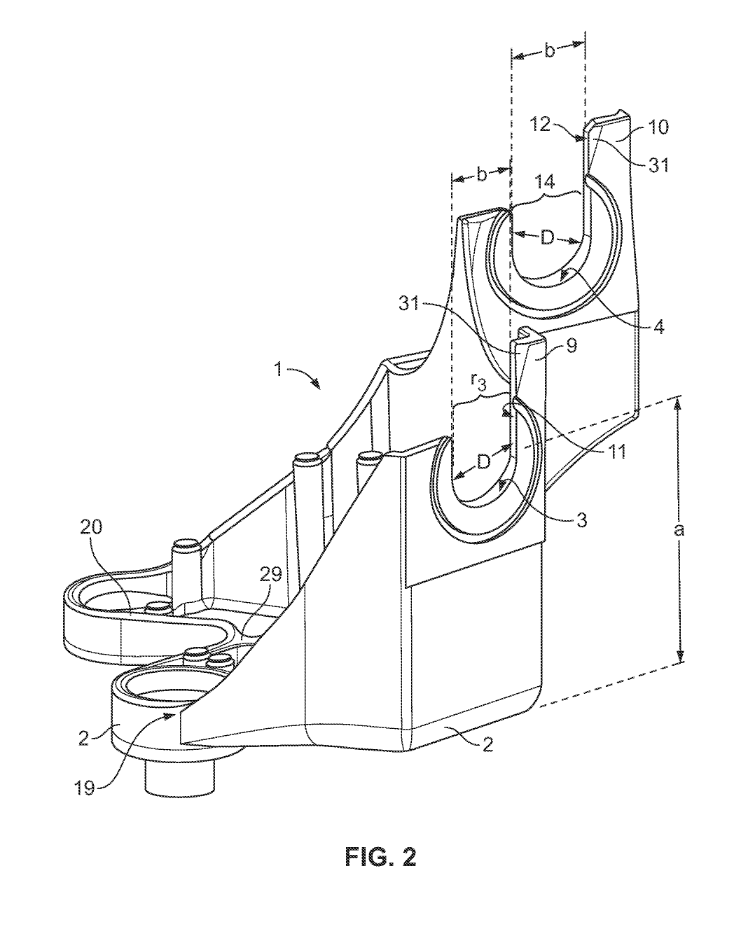

FIG. 2 shows a schematic perspective view of a shift cable holder 1 in detail. The shift cable holder 1 has a base area 2 in which the holes 19 and 20 (e.g., passages, openings) can be seen, which enable the shift cable holder 1 to be fixed on the transmission casing. The base area 2 is reinforced by ribs 29. At a distance from the base area 2, a retaining profile 3 is provided for a coupling element of a shift cable. To this end the retaining profile 3 has a diameter D in an opening 13. This opening 13 has a width b, which corresponds to the diameter D.

The retaining profile 3 goes over into a guide lug 9 with a guide edge 11. In its upper region the guide lug 9 has a frustroconical tapering 31. The frustroconical tapering 31 facilitates the latching or engagement into a channeling of a coupling element to be fixed in the retaining profile. In addition to the retaining profile 3, the shift cable holder 1 has a second retaining profile 4 having an opening 14 and a rod-shaped guide lug 10 with a guide edge 12, where the guide lug 10 has a frustroconical tapering 31 in its upper region in order to facilitate the insertion of a coupling element into the retaining profile 4.

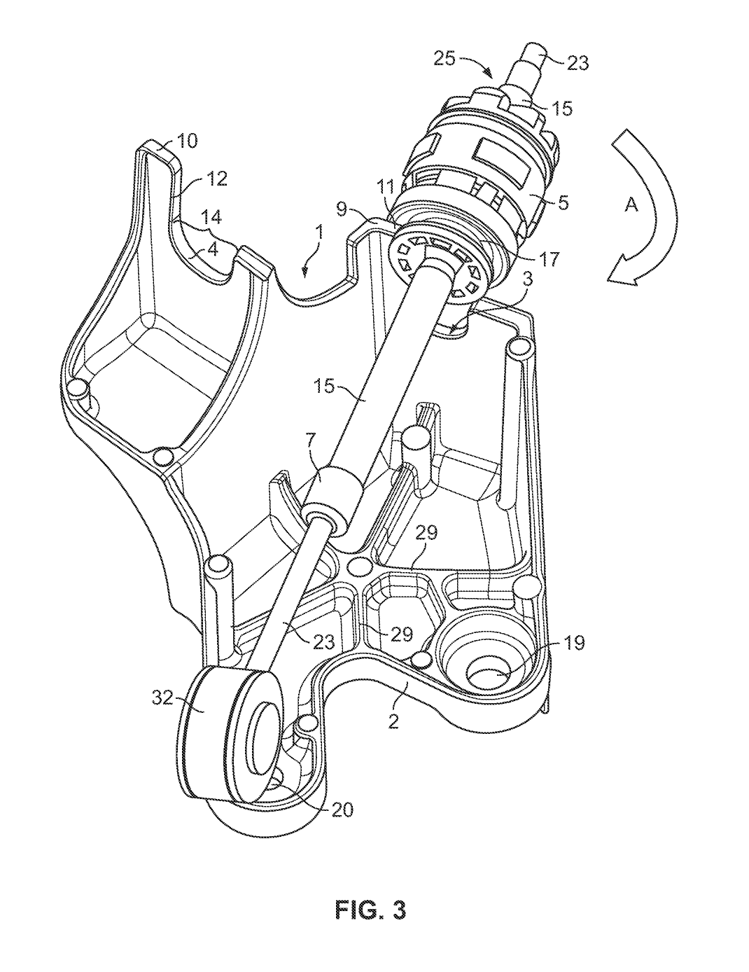

FIG. 3 shows a schematic perspective view of the shift cable holder 1 according to FIG. 2 when mounting a transmission-side selector cable end 7. The selector cable wire 23 projects from the selector cable end 7 that can be connected in an articulated manner with the aid of a transition element 32 to the selector lever of the transmission shown in FIG. 1. A coupling element 5 having a channeling 17 is fixed on the cable cladding 15 of the selector cable end 7. In order to be able to introduce the channeling 17 into the retaining profile 3 via the opening 13, the coupling element 5 with its channeling 17 can first be latched on the guide lug 9, as shown in FIG. 3, and turned in the direction of the arrow A until the channeling 17 formed by an annular groove is aligned in the direction of the retaining profile 3. Once this alignment is achieved, the coupling element 5 can be inserted in a sliding manner on the guide edge 11 of the guide lug 9 into the retaining profile 3. This insertion or latching of the channeling 17 of the coupling element is only carried out when the shift cable holder 1 is fixed on the transmission casing shown in FIG. 1 with the aid of the holes 19, 20 in the base area 2.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A shift cable holder for a transmission, comprising:
a base region;
a retaining profile configured to receive a coupling element of a shift cable end at a distance from the base region;
a guide lug that projects beyond the retaining profile and is fixed to the retaining profile and comprises a guide edge.

2. The shift cable holder according to claim 1, wherein the guide edge goes over tangentially into the retaining profile.

3. The shift cable holder according to claim 1, wherein the retaining profile is annular and comprises an opening toward a tangential guide edge of the guide lug, with a width that corresponds to a diameter of the coupling element.

4. The shift cable holder according to claim 1, wherein the coupling element of a selector cable end is fixed on a cable cladding and comprises an annular channeling that is configured to engage into the retaining profile.

5. The shift cable holder according to claim 4, wherein the guide edge of the guide lug has a thickness that is configured to the annular channeling of the shift cable end and configured to engage.

6. The shift cable holder according to claim 1, wherein the base region comprises at least one through hole.

7. The shift cable holder according to claim 1, wherein the base region comprises at least one fixing element that is disposed in the through hole and fixes the shift cable holder on a seat of a transmission casing.

8. The shift cable holder according to claim 7, wherein a selector cable projects from a selector cable end that extends as far as a selector lever on the transmission casing.

9. A shift cable retaining apparatus, comprising:
a shift cable holder, the shift cable holder comprising:
a base region;
a retaining profile configured to receive a coupling element of a shift cable end at a distance from the base region;
a guide lug that projects beyond the retaining profile and is fixed to the retaining profile and comprises a guide edge; and
two retaining profiles in which one selector cable end of a selector cable and one shift cable end of a shift cable are fixed with guide lugs assigned to retaining profiles, and
wherein a selector cable wire projecting is fixed in an articulated manner on a corresponding selector.

10. The shift cable retaining apparatus according to claim 9, wherein the guide edge goes over tangentially into the retaining profile.

11. The shift cable retaining apparatus according to claim 9, wherein the retaining profile is annular and comprises an opening toward a tangential guide edge of the guide lug, with a width that corresponds to a diameter of the coupling element.

12. The shift cable retaining apparatus according to claim 9, wherein the coupling element of a selector cable end is fixed on a cable cladding and comprises an annular channeling that is configured to engage into the retaining profile.

13. The shift cable retaining apparatus according to claim 12, wherein the guide edge of the guide lug has a thickness that is configured to the annular channeling of the shift cable end and configured to engage.

14. The shift cable holder according to claim 9, wherein the base region comprises at least one through hole.

15. A method for mounting a shift and a selector cable on a transmission casing, comprising:
providing a selector cable end and a shift cable end with a projecting selector,
wherein cable ends have coupling elements placed on the respective cable cladding,
fixing a shift cable holder having retaining profiles for the selector cable end and the shift cable end on the transmission casing that comprise an annular channeling of a coupling element;
latching the channeling of a respective coupling element into a guide edge of a guide lug;
turning a cable end into an alignment of a retaining profile while supporting the cable end on the guide edge;
sliding displaceable lowering of the coupling element along the guide lug into the retaining profile; and
articulated fixing of the cable ends on corresponding transmission levers.

16. The method according to claim 15, further comprising shrinking the coupling elements onto the cable cladding.

17. The method according to claim 15, further comprising seamlessly connecting the coupling element to the cable cladding.

18. The method according to claim 15, further comprising inserting an annular groove in the coupling element as the annular channeling.

19. The method according to claim 15, further comprising tapering a profile of the guide lug toward the guide edge in a frustroconical manner.
